(19) United States
(12) Patent Application Publication
(10) Pub. No.: US 2010/0238933 A1
(43) Pub. Date: Sep. 23, 2010

(54) COMMUNICATION APPARATUS

(75) Inventors: Takeshi ASADA, Kawasaki (JP); Osamu Wakimoto, Kawasaki (JP); Hideaki Ookoshi, Kawasaki (JP); Nobue Komatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/725,873

(22) Filed: Mar. 17, 2010

(30) Foreign Application Priority Data
Mar. 19, 2009 (JP) 2009-68109

(51) Int. Cl. H04L 12/28

(52) U.S. Cl. 370/392

(57) ABSTRACT

A communication apparatus includes a signal termination unit that includes a point data management unit and performs reception processing by receiving a signal including an address code for identifying a plurality of remote signaling points, and a plurality of call processing units that perform call processing for the plurality of the remote signaling points, the point data management unit manages call-processing point data, and wherein the signal termination unit, upon receipt of the signal, extracts a code of the non-masked range of the address code having a wild card, and recognizes the call processing unit number corresponding to the extracted code of the non-masked range by referring to the call-processing point data, and transmits to the call processing unit having the recognized call processing unit number the corresponding address code describing all the bits of the code set in the masked range and the code set in the non-masked range.

### CROSS-REFERENCE TO RELATED APPLICATIONS

This application is based upon and claims the benefit of priority of the prior Japanese Patent Application No. 2009-068109, filed on Mar. 19, 2009, the entire contents of which are incorporated herein by reference.

### BACKGROUND

For various common channel signaling systems used in telecommunications, the following three common channel signaling protocols have been specified in accordance with physical interfaces: Message Transfer Part 3 (MTP3) for Synchronous Transfer Module (STM), Message Transfer Part 3b (MTP3b) for Asynchronous Transfer Mode (ATM), and M3UA (Signaling System 7 (SS7) Message Transfer Part 3 (MTP3) User Adaptation Layer) for Internet Protocol (IP). These are protocols that specify the protocol for transfer of messages between signaling end points which are nodes of a signaling network.

Note that MTP3 was first developed with the purpose of applying it to an STM network, and MTP3b was developed so as to be applicable to an ATM network, by making some modifications to MTP3. Then M3UA was developed so as to be applicable to an IP network while maintaining the reliability of MTP signal transfer.

FIG. 13 is a diagram illustrating an exemplary configuration of a signaling network. A common channel signaling network 5 includes signaling end points (STPs) 51 and 52, and signaling transfer points (STPs) 41 to 46. The signaling end points 51 and 52, like telephone switching stations, terminate signals such as call processing signals. The signaling transfer points 41 to 46 transfer signals to the signaling end points 51 and 52. The signaling transfer points 41 to 46 correspond to routers in IP networks.

Here, the routing method of a common channel signaling network is described in comparison with a routing method used in an IP network. In an IP network, transfer of messages is performed using IP addresses as identifiers, whereas in a common channel network, messages are transferred using identifiers called point codes (PCs). A PC is information uniquely identifying a signaling end point.

An IP header field specifying an IP address includes an originating IP address and a destination IP address. Similarly to this, an originating PC (OPC) and a destination PC (DPC) are set in a field called a routing label field that defines PCs in a common channel signaling network.

FIG. 14 is a diagram illustrating the format of a PC. A PC according to a domestic standard is defined by 16 bits that constitute a two-layer numbering system of a main zone number and a subzone number.

M denotes the main zone numbers (00 to 31), and is a 5-bit code specifying a large area such as the Kanto area or Tohoku area. In the case of a fixed-line telephone network, for example, the two lower decimal digits indicating 03 represent the Tokyo area.

S denotes the subzone numbers (00 to 15), and is a 4-bit code specifying any of subareas into which a respective main zone is divided. In the case of a fixed-line telephone network, numbers 00 and 01 are assigned to signaling transfer points, and numbers 02 and above are assigned to the types of signaling end points.

U denotes local unit numbers (000 to 127) within a subzone, and is a 7-bit code specifying a signaling point. Such a unique 7-bit code is assigned to one signaling end point in a specific subzone.

By using the above-described codes M, S, and U, it can be determined which signaling end point located in which subzone of which main zone, a given signaling end point is. Note that PCs are assigned not only to signaling end points but also to signaling transfer points.

Usually, a wildcard is used to specify a range of PCs at the time of notification of a network management signal (signal containing information such as a line error, congestion, recovery from a failure or the like). A wildcard is a function used to specify certain information. In general, a special character is inserted into a specified word, or masking is performed, whereby a desired character string is expressed.

When a wildcard is used to specify a range of PCs, masking is used. For example, when M specifies 03 while S and U are masked (S and U are made to be wild cards), all the signaling points in the Tokyo area can be subjected to processing.

When all the signaling points in the Tokyo area having a subzone number S=00 are to be processed, a wild card is used for U, while making M=03 and S=00. (This use of a wild card is similar to the case in which, in an IP network, data can be transferred to any nodes having IP addresses belonging to a subnet, by setting the subnet in a router.)

In the signaling network 5, in order to enable continued service by, for example, changing a signal route even when a failure or signal congestion occurs in a signaling link, a test signal is periodically passed among adjacent signaling points to detect a failure or signal delay.

FIG. 15 is a diagram illustrating the flow of test signals. In the signaling network 5, the signaling end points 51 and 52 and the signaling transfer points 41 to 46 periodically transmit test signals to adjacent points. A link error (test signal communication state) is detected by determining whether or not the test signals can be received from adjacent points.

Referring to FIG. 15, the signaling end point 52 and the signaling transfer points 43 and 46 are located in the Tokyo area (M=03). The subzone number (S) and local unit number (U) of the signaling end point 52 are respectively 02 and 001; the subzone number (S) and local unit number (U) of the signaling transfer point 43 are respectively 00 and 001; and the subzone number (S) and local unit number (U) of the signaling transfer point 46 are respectively 00 and 002.

FIG. 16 is a diagram illustrating a signaling network when failures have occurred. It is assumed that line errors have occurred in links L1 and L2 in the signaling network 5. The signaling transfer point 42 recognizes that a failure has occurred in the link L1 because it cannot receive a test signal transmitted from the signaling transfer point 43. Likewise, the signaling transfer point 45 recognizes that a failure has occurred in the link L2 because it cannot receive a test signal transmitted from the signaling transfer point 46. Then the signaling transfer points 42 and 45 respectively transmit transfer-prohibited signals (a type of network management signal) to adjacent signaling points to prohibit data transfer due to the occurrence of failures.

FIG. 17 is a diagram illustrating the operation of transmitting a transfer-prohibited signal. The signaling transfer point 42 transmits transfer-prohibited signals to the signaling transfer points 41 and 45. The signaling transfer point 45 transmits transfer-prohibited signals to the signaling transfer points 42 and 44. The transfer-prohibited signals are eventually transferred to the signaling end point 51.

The transfer-prohibited signal also includes a notification of areas that can no longer be connected to, using a PC. Here, a wild card is used for information about the target points (affected points) since it is not efficient to describe all the PCs of the target points.

In the above example, if connection to any points in the Tokyo area has become impossible due to the failures, the setting of M=003, S=xx, and U=xx (x means masking) is made in the signaling transfer points 42 and 45, and a transfer-prohibited signal including a PC having such a description is transferred.

FIG. 18 is a diagram illustrating settings in a transfer-prohibited signal. When it is detected that a signal cannot be transferred to any points whose main zone numbers (M) indicate 03, PC setting is performed such that only M is specified, while S and U are wild cards.

A signal pattern p1 is used as the setting of target points in a transfer-prohibited signal in the case of MTP3/MTP3b (STM/ATM), and a signal pattern p2 is used in the case of M3UA (IP).

In FIG. 18, the “specified range” field indicates the number of bits that are made to be wild cards. In the present example, the “specified range” field is set to 11, since 11 bits (U: 7 bits, S: 4 bits), other than the 5 bits indicating M=03, are masked by wild cards.

FIG. 19 is a list of network management signals of respective protocols. The network management signals include a transfer-allowed signal, a transfer-restricted signal, a route-set-test signal, and a transfer-controlled signal, in addition to the above-described transfer-prohibited signal. In respective protocols, these signals have names and ID codes assigned thereto for identifying the respective signals.

For the sake of reference, the transfer-prohibited signal is called a transfer-prohibited (TFP) message and the ID code thereof is 0x14 in the case of MTP3/MTP3b, whereas it is called a destination unavailable (DUNA) message and the ID code thereof is 0x0001 in the case of M3UA.

A technique of the related art has been proposed in which shortage in signaling point codes in the common channel signaling system is solved by decreasing the number of signaling point codes assigned to signaling transfer points (refer to Japanese Unexamined Patent Application Publication No. 2005-184467).

### SUMMARY

A communication apparatus includes a signal termination unit that includes a point data management unit and performs reception processing by receiving a signal including an address code for identifying a plurality of remote signaling points and a plurality of call processing units that perform call processing for the plurality of the remote signaling points. When a predetermined range of the address code is masked by a wild card and a signal is received which includes an address code constituted by a masked range and a non-masked range, the masked range being a masked portion of the address code and the non-masked range being a range of the address code not masked, the point data management unit manages call-processing point data, which is a list showing which of the call processing units performs call processing for the remote signaling point specified by the given address code, by associating a call processing unit number for identifying the call processing unit with the address code describing all bits of a code set in the masked range and a code set in the non-masked range, and herein the signal termination unit, upon receipt of the signal, extracts a code of the non-masked range of the address code having a wild card, and recognizes the call processing unit number corresponding to the extracted code of the non-masked range by referring to the call-processing point data, and transmits to the call processing unit having the recognized call processing unit number the corresponding address code describing all the bits of the code set in the masked range and the code set in the non-masked range.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

### BRIEF DESCRIPTION OF DRAWINGS

FIG. 1 is a diagram illustrating an exemplary configuration of a communication apparatus;

FIG. 2 is a diagram illustrating an exemplary configuration of a common channel signaling network;

FIG. 3 is a diagram illustrating a signal format;

FIG. 4 is a diagram illustrating a signal format;

FIG. 5 is a diagram illustrating a signal format;

FIG. 6 is a diagram illustrating call-processing point data;

FIG. 7 is a diagram illustrating processing for extracting a code of a non-masked range.

FIG. 8 is a diagram illustrating corresponding call processing unit numbers in call-processing point data;

FIG. 9 is a diagram illustrating how PCs are transferred from a signaling unit to the call processing units;

FIG. 10 is a diagram illustrating an exemplary configuration of a modification example of a signaling end point;

FIG. 11 is a diagram illustrating termination-processing point data;

FIG. 12 is a diagram illustrating how the call-processing point data is searched for corresponding PCs on the basis of a related index;

FIG. 13 is a diagram illustrating an exemplary configuration of a signaling network;

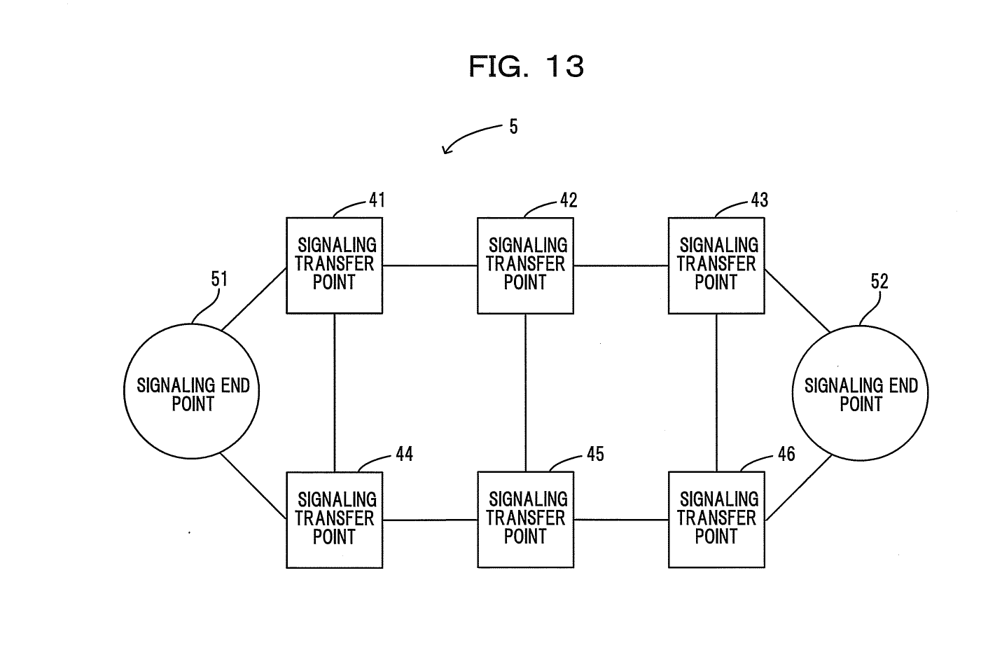

FIG. 14 is a diagram illustrating the format of a PC;

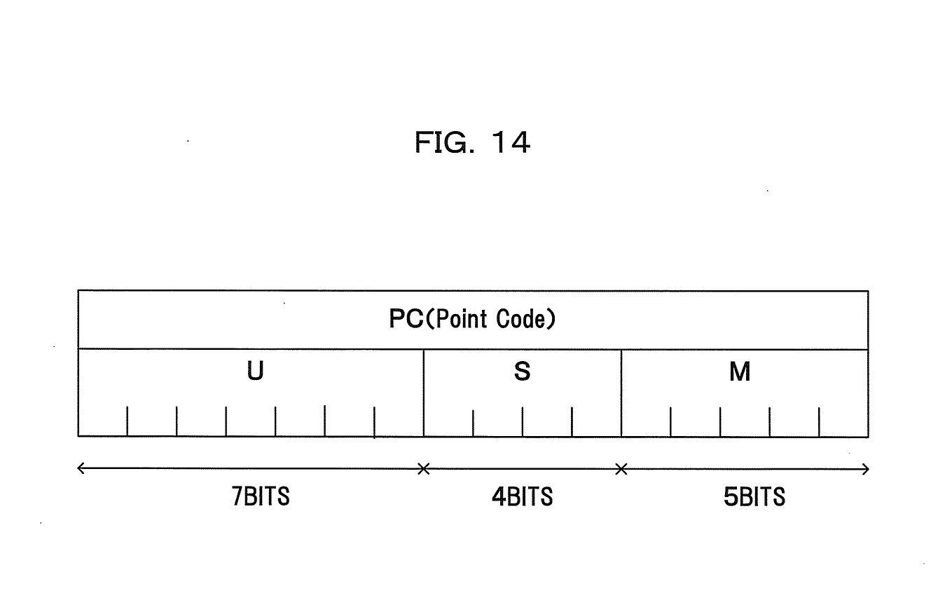

FIG. 15 is a diagram illustrating the flow of test signals;

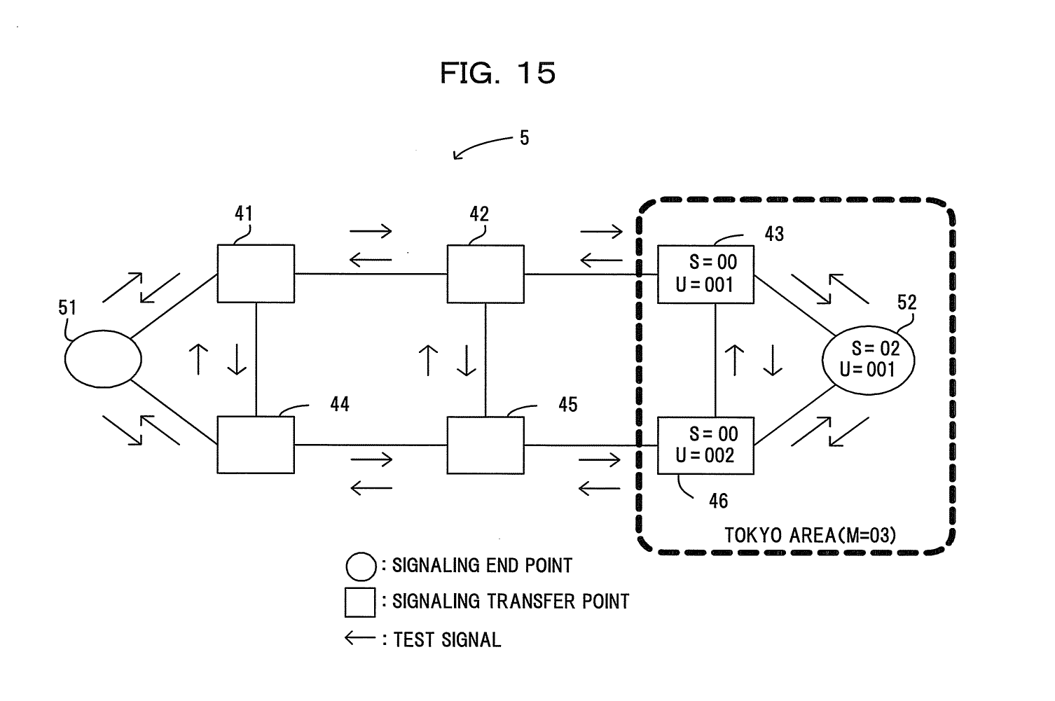

FIG. 16 is a diagram illustrating a signaling network when failures have occurred;

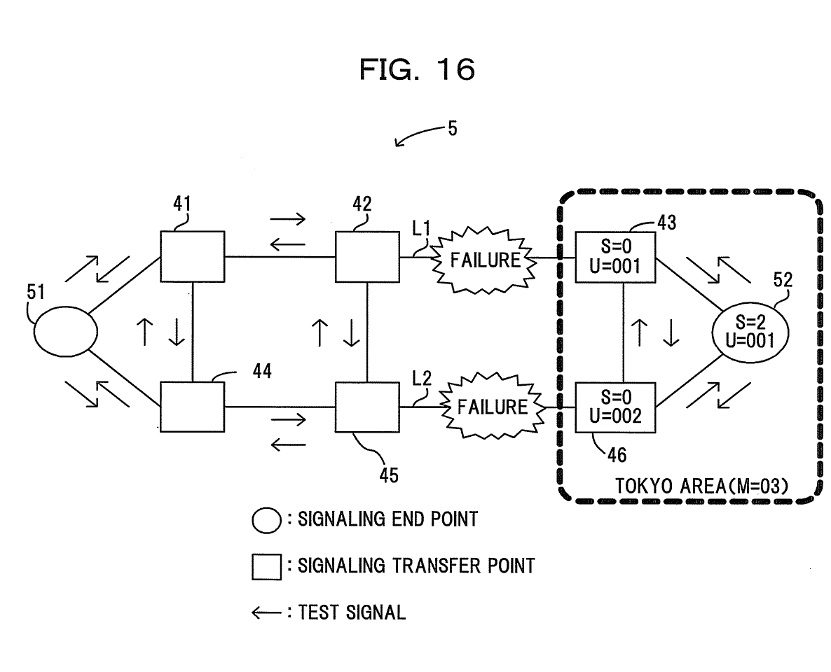

FIG. 17 is a diagram illustrating the operation of transmitting a transfer-prohibited signal;

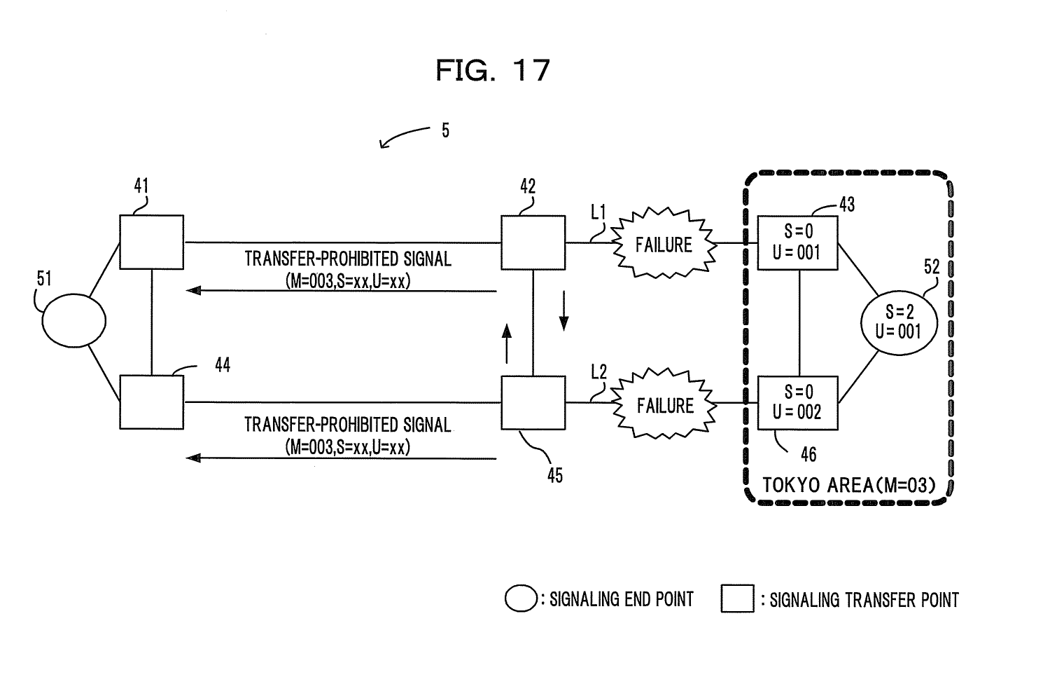

FIG. 18 is a diagram illustrating settings in a transfer-prohibited signal;

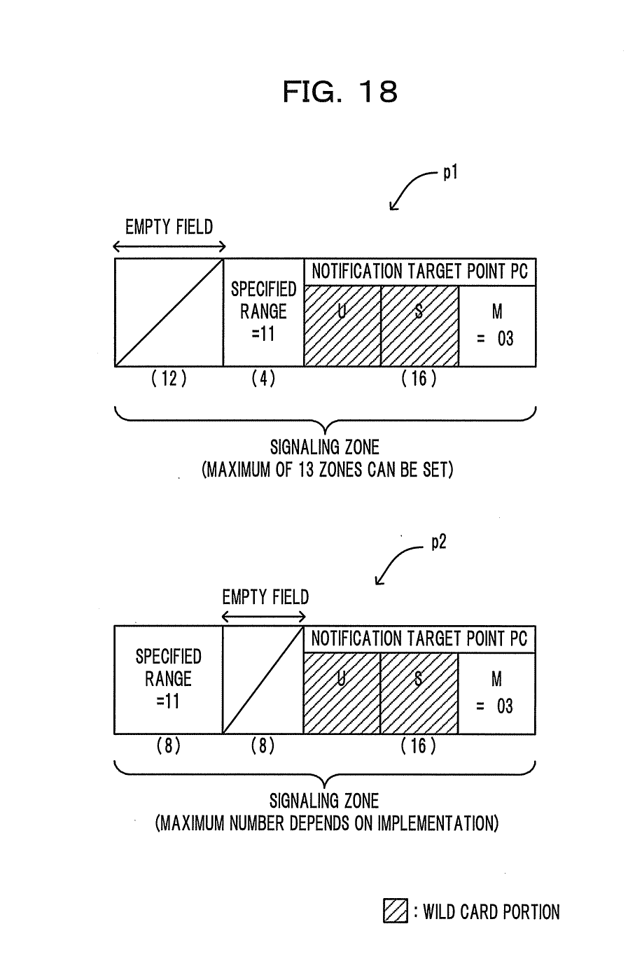

FIG. 19 is a list of network management signals of respective protocols;

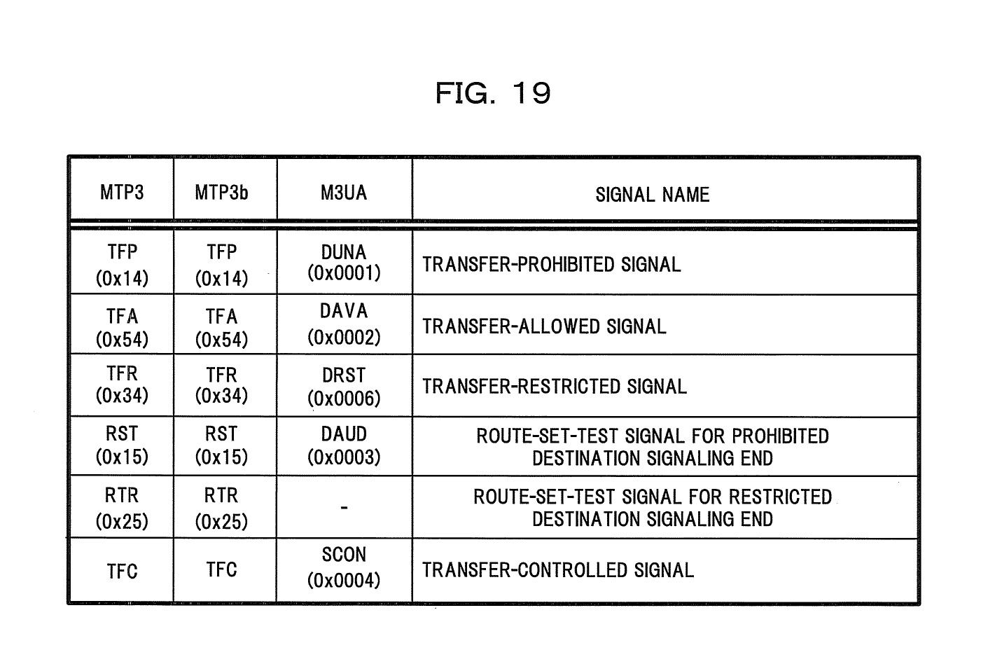

FIG. 20 is a diagram illustrating a configuration of a signaling point; and

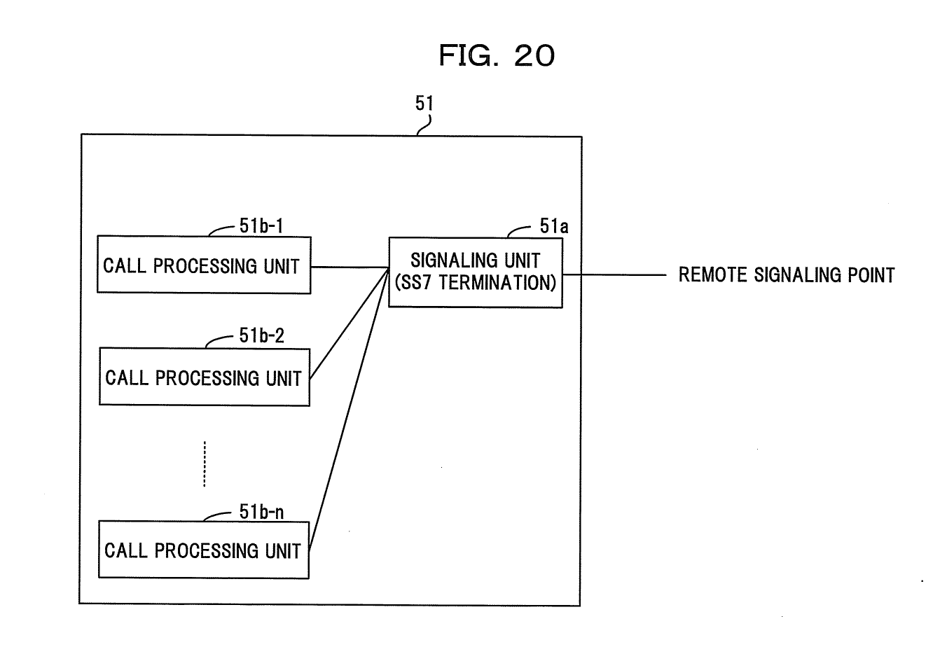

FIG. 21 is a diagram illustrating the operation of transferring a PC in which a masked range has been developed.

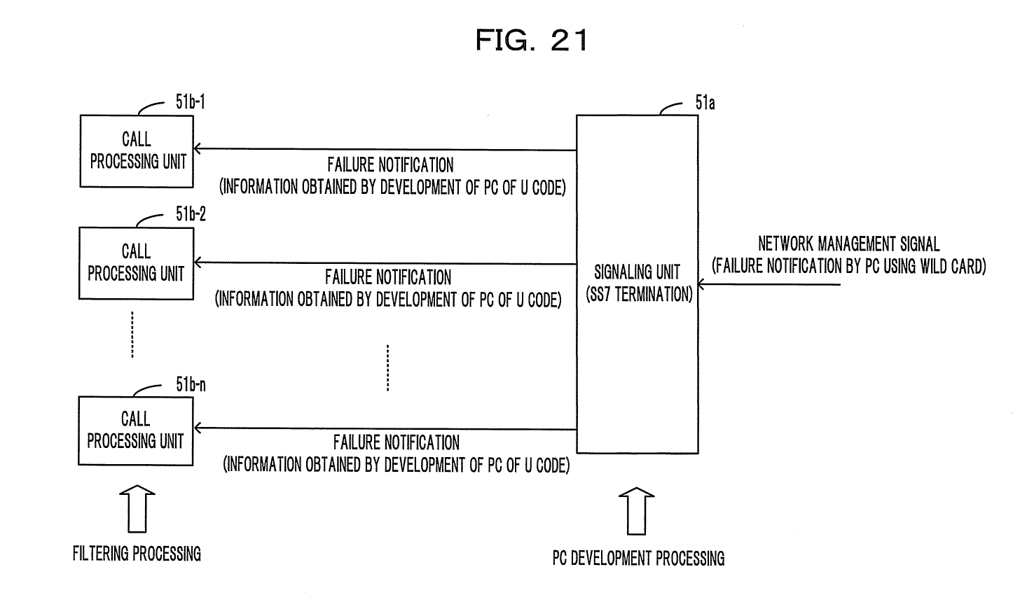

### DESCRIPTION OF EMBODIMENTS

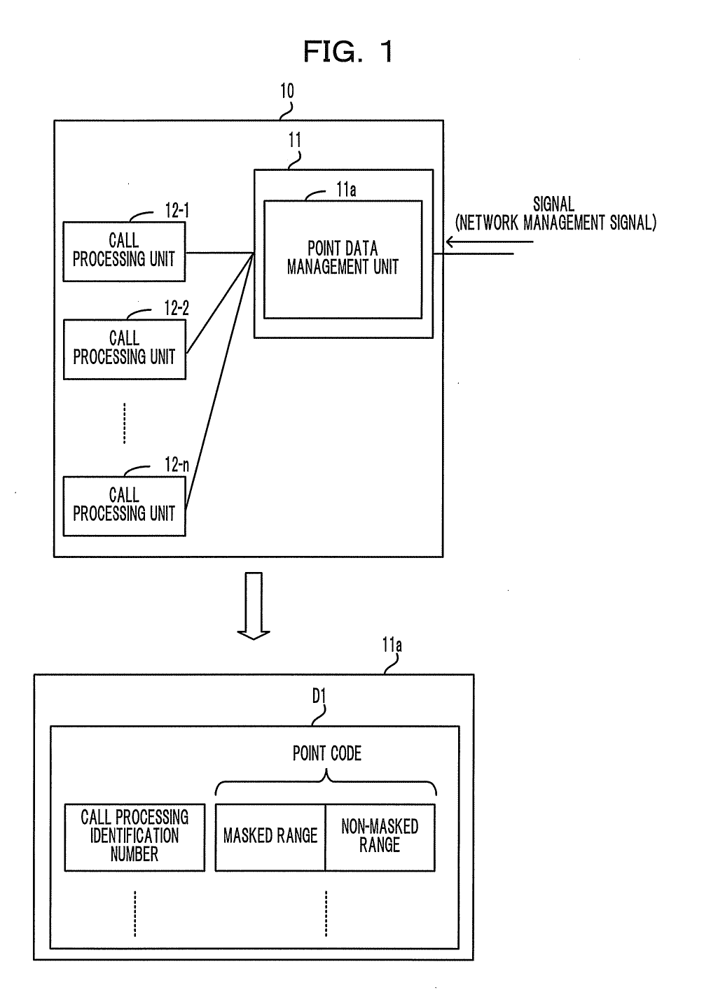

Hereinafter, embodiments are described with reference to the drawings. FIG. 1 is a diagram illustrating an exemplary configuration of a communication apparatus.

A communication apparatus 10 includes a signal termination unit 11 and call processing units 12-1 to 12-n.

The signal termination unit 11 includes a point data management unit 11a and receives a signal (network management signal) including an address code which is address information for identifying a remote signaling point, and performs reception processing. The call processing units 12-1 to 12-n perform call processing for a plurality of remote signaling points. Hereinafter, the address code is also called a point code (PC).

Here, it is assumed that a PC is constituted by a masked range corresponding to a specified portion which is masked by a wild card and a non-masked range which is not masked. It is also assumed that the communication apparatus 10 is notified of a network management signal including such a PC having a wild card.

The point data management unit 11a manages call-processing point data D1, by associating each of the respective identification numbers (call processing unit numbers) of the call processing units 12-1 to 12-n with a PC including all the bits of the code set in the masked range and the code set in the non-masked range. The call-processing point data D1 is a list showing which call processing unit performs call processing for a remote signaling point specified in a given PC.

The signal termination unit 11, upon receipt of a network management signal, extracts the code set in the non-masked range of a PC in the case of a PC having a wild card. Then with reference to the call-processing point data D1, the signal termination unit 11 recognizes a call processing unit number corresponding to the code set in the extracted non-masked range, and sends a corresponding whole PC including the codes of the non-masked range and masked range to a call processing unit that has the recognized call processing unit number.

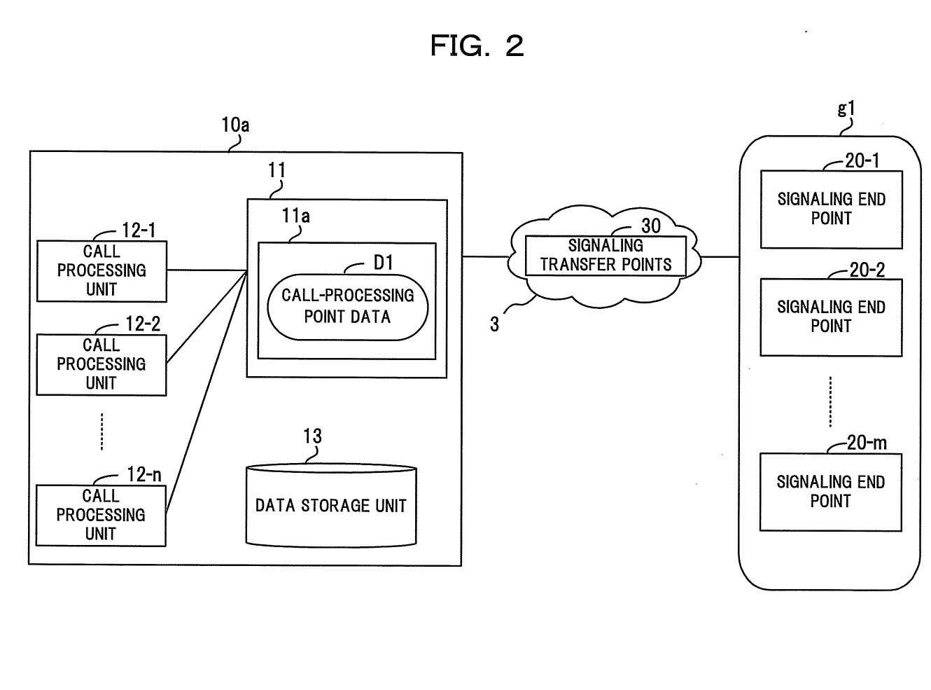

The case in which the communication apparatus 10 is applied to a signaling end point that performs reception processing in accordance with a common channel signaling system will be described in detail below. FIG. 2 is a diagram illustrating an exemplary configuration of a common channel signaling network. A signaling end point 10a (corresponding to the communication apparatus 10 illustrated in FIG. 1) is connected via a common channel signaling network (Common Channel Signaling System No. 7 (SS7) network) 3 to and communicates with a remote signaling point group g1. The SS7 network 3 includes a plurality of signaling transfer points 30, and the remote signaling point group g1 includes signaling end points 20-1 to 20-m.

Here, it is assumed that an event such as a line failure, congestion, or recovery occurs at the physical interface (MTP3/MTP3b/M3UA) of the common channel signaling network 3, and a network management signal for notification of such an event is generated by the signaling transfer point 30 and flows from the signaling transfer point 30 to the signaling end point 10a. In this case, the signaling transfer point 30 that detected a line failure or the like can make a notification of the state of communication between the signaling end point 10a and the remote signaling point group g1 using a network management signal utilizing a wild card.

The signaling end point 10a, while performing call processing for the remote signaling point group g1, receives a network management signal having a wild card transmitted from the signaling transfer point 30, when the signaling transfer point 30 detects generation of or recovery from a failure.

The signaling end point 10a includes a signaling unit 11 (corresponding to the signal termination unit 11 illustrated in FIG. 1) and the call processing units 12-1 to 12-n, and a data storage unit 13. The signaling unit 11 includes the point data management unit 11a that manages the call-processing point data D1.

The signaling unit 11 performs termination processing (signaling processing) for various messages of Common Channel Signaling System No. 7. The call processing units 12-1 to 12-n perform call processing for the corresponding remote signaling end points 20-1 to 20-m. The data storage unit 13 is a maintenance server that stores various data required for signal termination processing and call processing.

The call processing units 12-1 to 12-n are capable of performing load distributed processing, and hence, a configuration is employed in which n of the call processing units are provided for one system unit. In the processing performed by the call processing units 12-1 to 12-n, if the call processing load for a remote signaling end point is low, one or only a few call processing units deal with the signaling end point, and if the call processing load for a remote signaling end point is high, a greater number of call processing units deal with the signaling end point.

For example, when the signaling end point 10a and the signaling end point 20-1 are communicating, only the call processing unit 12-1 performs call processing for the signaling end point 20-1 if the call processing load for the signaling end point 20-1 is low. If the call processing load for the signaling end point 20-1 is high, call processing for the signaling end point 20-1 is performed using the two call processing units 12-1 and 12-2. In this manner, the number of call processing units used may be increased or decreased in accordance with the call processing load for signaling end points.

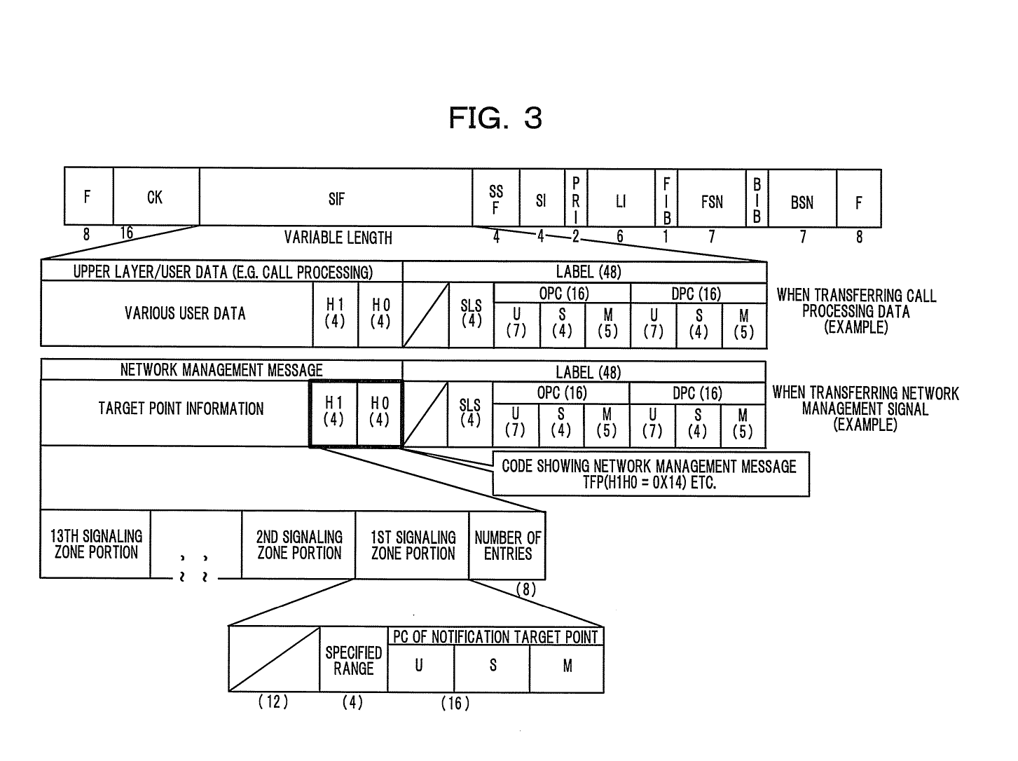

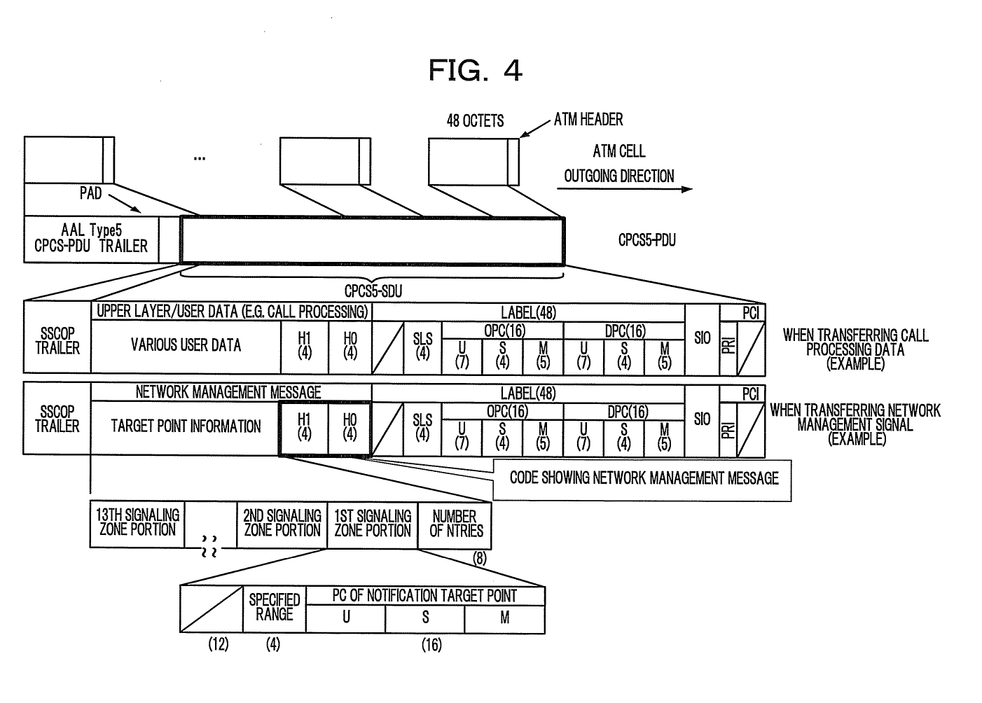

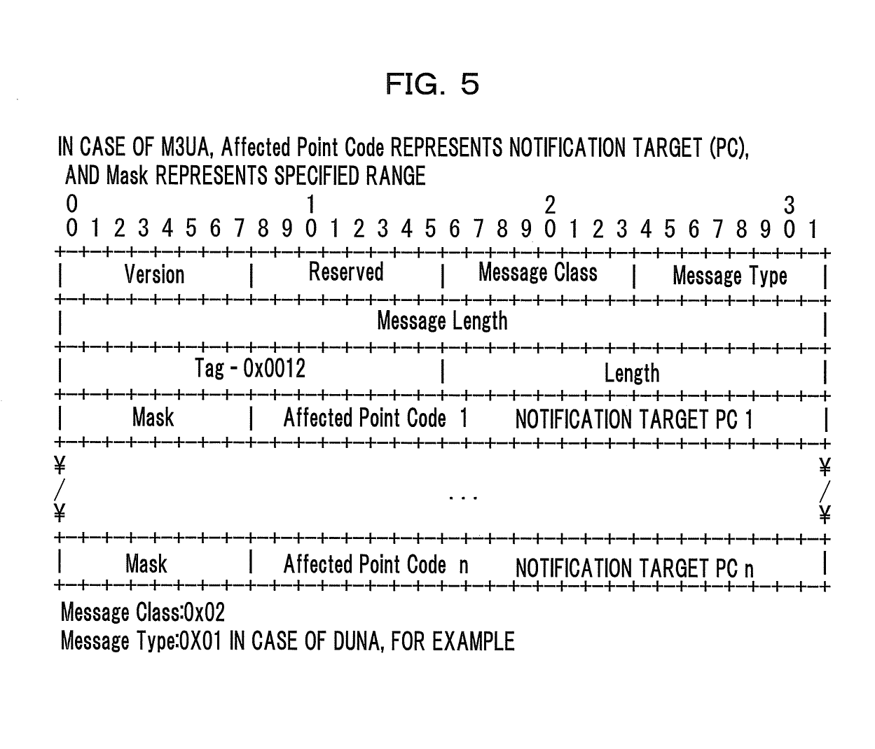

FIGS. 3 to 5 are diagrams illustrating signal formats. These figures illustrate formats of data and a signal sent/received between the signaling end point 10a and the remote signaling point group g1. FIG. 3 illustrates a signal format in the case of MTP3 (STM), FIG. 4 illustrates a signal format in the case of MTP3b (ATM), and FIG. 5 illustrates a signal format in the case of M3UA.

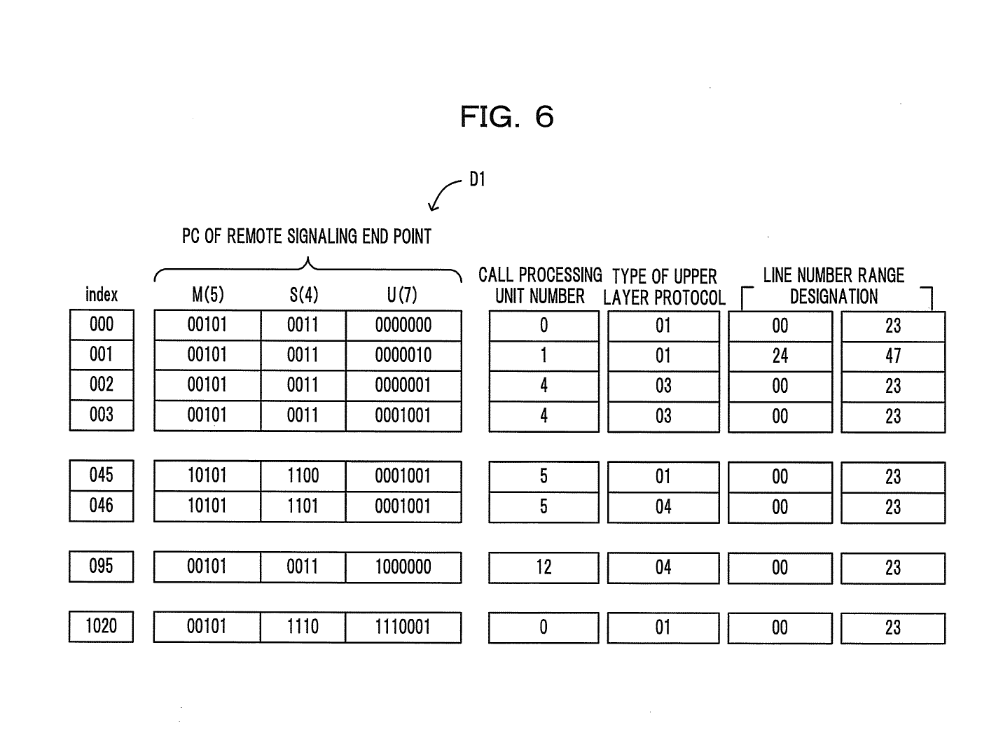

The call-processing point data D1 managed by the point data management unit 11a will now be described. FIG. 6 is a diagram illustrating the call-processing point data D1. The call-processing point data D1, which describes the PCs of remote signaling points for which call processing is performed, is point data used for specifying a unique PC when a remote signaling point is to be selected.

The call-processing point data D1 includes the following attribute items: an index, the PC (respective designation ranges M, S, and U) of a remote signaling end point, a call processing unit number, the type of upper protocol, and a line number range designation.

The call processing number is an identification number for identifying each of the call processing units 12-1 to 12-n. The type of upper protocol is a code that indicates what protocol each call processing unit supports. The line number range designation describes line numbers of lines to be processed when call processing is performed.

Now, description is made of the operation of the signaling end point 10a when the signaling end point 10a has received a network management signal including a PC having a wild card. Here, the case is considered where the signaling end point 10a has received a notification of a PC in which the remote signaling point designation range (U range) specifying a unique remote signaling point is masked using a wild card and only the zone designation range (M-S range) specifying a zone that includes remote signaling points is shown. Note that the U range corresponds to a masked range and the M-S range corresponds to a non-masked range.

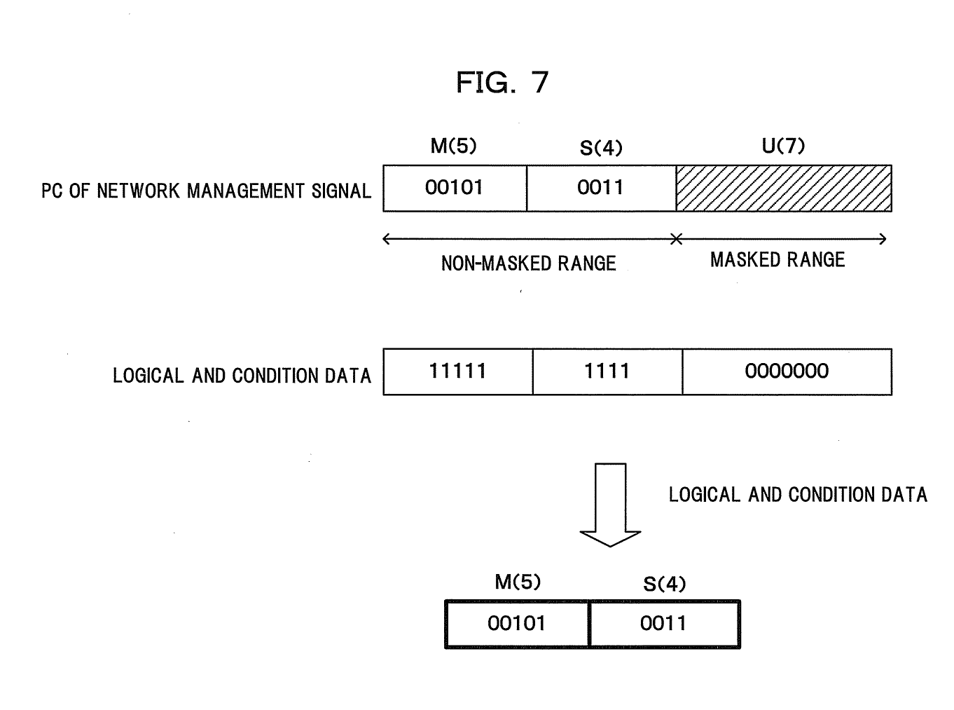

The signaling unit 11, upon receipt of a management signal that includes a PC having a wild card, extracts a code set in the non-masked range. FIG. 7 is a diagram illustrating the processing for extracting the code set in the non-masked range. It is assumed that the signaling unit 11 has received a PC having a code 00101 set in the M range and a code 0011 set in the S range, with the 7-bit U range being masked.

The signaling unit 11 prepares logical AND condition data constituted by 5 bits, corresponding to the M range, having a value of 11111; 4 bits, corresponding to the S range, having a value of 1111; and 7 bits, corresponding to the U range, having a value of 0000000.

Then, the signaling unit 11 computes an AND operation of the received PC and the logical AND condition data, and extracts data corresponding to “1” and recognizes this extracted result as the value of the non-masked range. In this example, the signaling unit 11 extracts 001010011 and recognizes this value as the value of the non-masked range.

Note that, since the 7-bit U range is a masked range in the above example, the logical AND condition data was made to be all “0s” as a code corresponding to the U range, and all “1s” as a code corresponding to the M-S range, whereby the logical AND operation was computed.

In another example where the 11-bit S-U range is a masked range, the logical AND condition data is set such that the code corresponding to the S-U range indicates all “0s” and the code corresponding to the M range indicates all “1s”.

When the masked range can be defined on a bit-by-bit basis, and if the upper 3 bits of the U range are masked, for example, a portion corresponding to this range is made to be all “0s” with the rest of the range being made to be all “1s”. In this manner, any value can be set in the logical AND condition data on a bit-by-bit basis.

When code data are extracted as 00101 for the M range and as 0011 for the S range through the above described code extracting processing for the non-masked range, the signaling unit 11 recognizes a call processing unit number corresponding to the extracted code set in the non-masked range by referring to the call-processing point data D1.

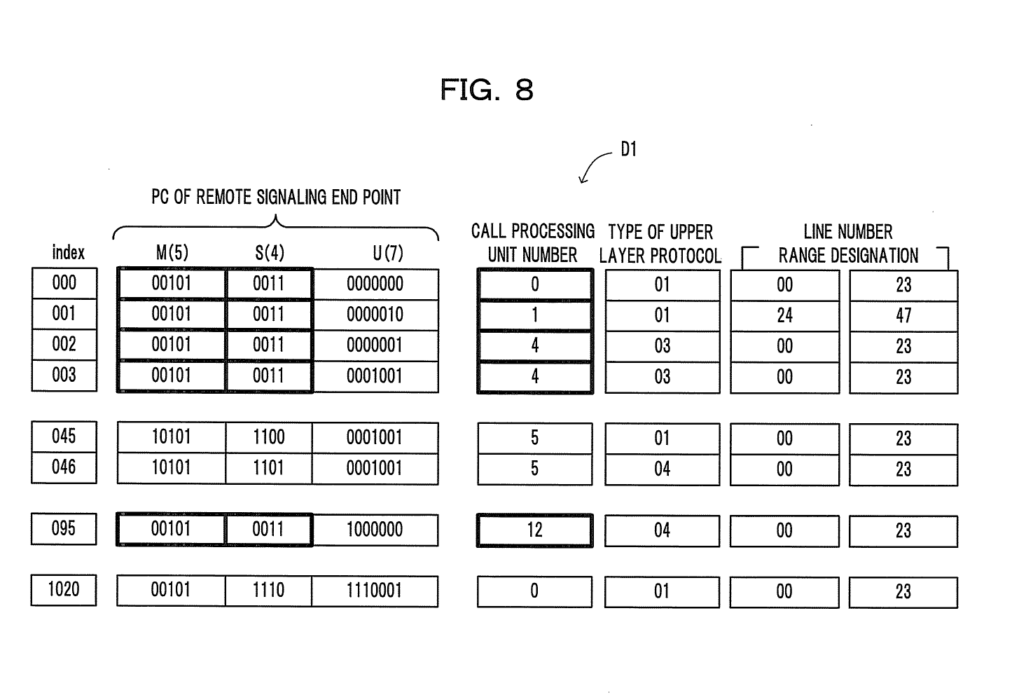

FIG. 8 is a diagram illustrating the corresponding call processing unit numbers in the call-processing point data D1. The signaling end point 10a is to process signals from signaling end points that exist in a zone corresponding to M=00101 and S=0011. In the call-processing point data D1, call processing units having unit numbers 0, 1, 4, and 12 are in charge of the call processing for M=0011 and S=0011.

Hence, for signaling end points within the remote signaling point group g1 existing in a zone specified by M=00101 and S=0011, call processing unit #0 (call processing unit having a unit number 0), performs call processing for the signaling end point having a code U=0000000, and call processing unit #1 (call processing unit having a unit number 1) performs call processing for the signaling end point having a code U=0000010.

Call processing unit #4 (call processing unit having a unit number 4) performs call processing for the signaling end point having a code U=0000001 and the signaling end point having a code U=0001001, and call processing unit #12 (call processing unit having a unit number 12) performs call processing for the signaling end point having a code U=1000000.

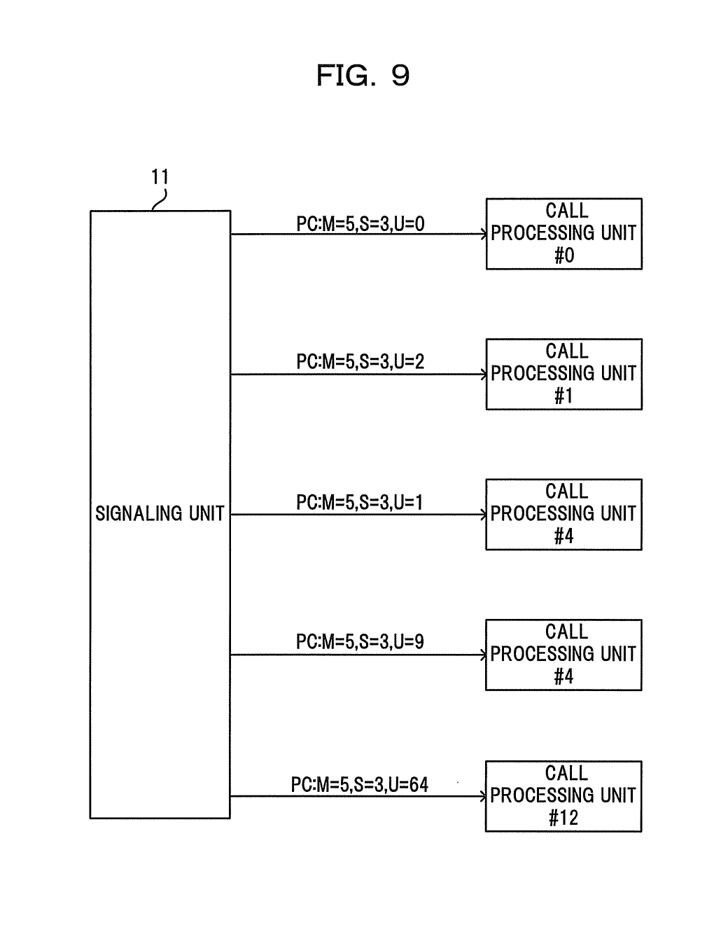

FIG. 9 is a diagram illustrating how PCs are transferred from the signaling unit 11 to the call processing units. The signaling unit 11 transfers all the bits of M, S, and U of a PC containing the information that M=00101, S=0011, and U=0000000 to call processing unit #0. In addition, the signaling unit 11 transfers all the bits of M, S, and U of a PC containing the information that M=00101, S=0011, and U=0000010 to call processing unit #1. Furthermore, the signaling unit 11 transfers all the bits of M, S, and U of a PC containing the information that M=00101, S=0011, and U=1000000 to call processing unit #12.

Regarding call processing unit #4, two call processing units having unit number=4 assigned thereto perform call processing. Hence, the signaling unit 11 transfers all the bits of M, S, and U of a PC containing the information that M=00101, S=0011, and U=0000001 to one call processing unit #4 among the two, and transfers all the bits of M, S, and U of a PC containing the information that M=00101, S=0011, and U=0001001 to the other call processing unit #4.

As described above, a configuration is employed in which, when the signaling unit 11 of the signaling end point 10a that has received a network management signal regarding remote signaling points sends a notification to the call processing units, only the PCs of remote signaling points which are to be served by the respective call processing units are sent, by directly extracting PCs of the target signaling points on the basis of the network management signal with a wild card and the call-processing point data D1. Employing such a configuration allows the load of processing network management signals to be decreased and serviceability to be increased.

In addition, a configuration is employed in which, when the load of call processing for remote signaling points is high, by creating the call-processing point data D1 such that a plurality of call processing unit numbers are assigned to a PC that describes the all the bits of a code set in a masked range and a code set in a non-masked range, load distributed processing is performed using the corresponding plurality of the call processing units.

In this manner, since load distributed processing can be set for call processing using the call-processing point data D1, efficient load distribution is realized, allowing management quality to be enhanced.

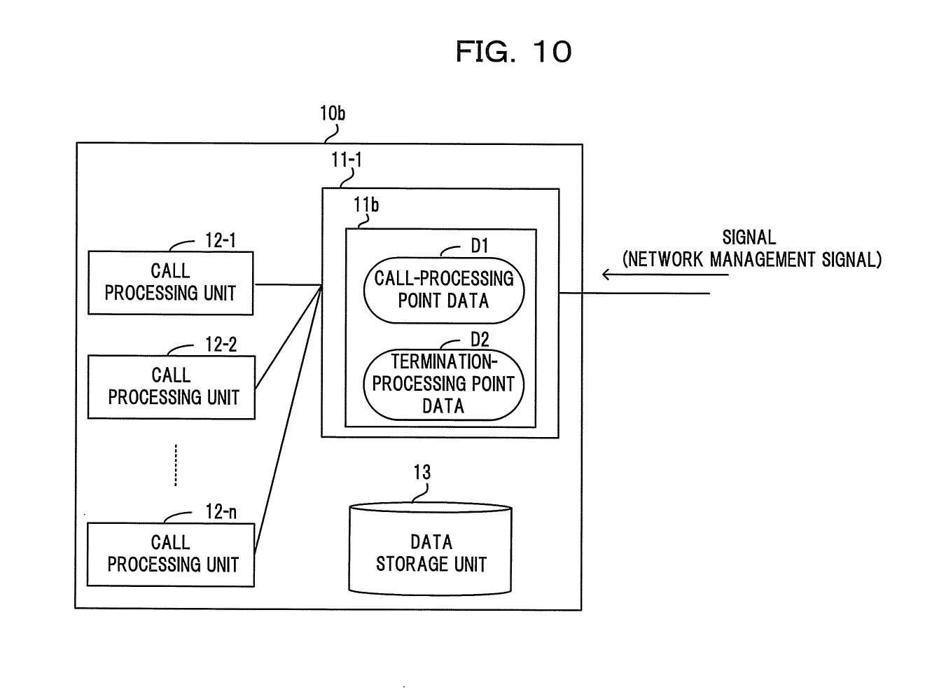

An exemplary modification will now be described. FIG. 10 is a diagram illustrating an exemplary configuration of a modification example of a signaling end point. A signaling end point 10b includes a signaling unit 11-1, call processing units 12-1 to 12-n, and a data storage unit 13. The signaling unit 11-1 includes a point data management unit 11b which manages call-processing point data D1 and termination-processing point data D2.

Now, description is made of the operation of the signaling end point 10b when the signaling end point 10b has received a network management signal including a PC having a wild card. Here, the case is considered where the signaling end point 10b has received a notification of a PC in which a remote signaling point designation range (U range) specifying a unique remote signaling point is masked using a wild card and only a zone designation range (M-S range) specifying a zone that includes remote signaling points is shown.

A signaling unit 11-1, upon receipt of a management signal that includes a PC having a wild card, extracts a code set in a non-masked range. Since the code extraction processing is the same as that described above using FIG. 7, the description thereof is omitted. Then, the termination-processing point data D2 and the call-processing point data D1 are searched for all-bit PCs to be sent to call processing units.

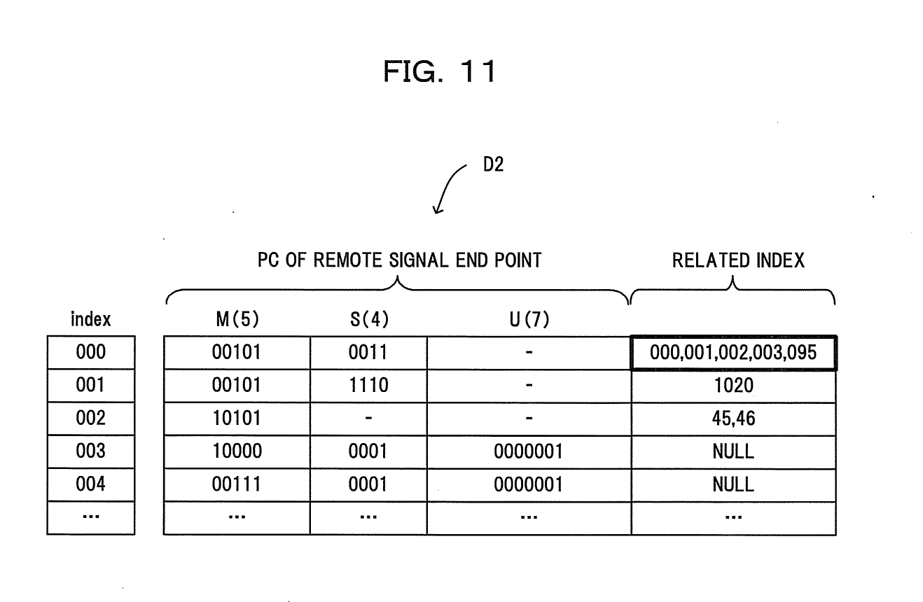

FIG. 11 is a diagram illustrating the termination-processing point data D2. The termination-processing point data D2 is a list of PCs that are acceptable to the signaling end point 10b itself. The PCs of the remote signaling end points 20-1 to 20-m, i.e., the main zone numbers (M), subzone numbers (S), and local unit numbers (U) of the respective remote signaling end points 20-1 to 20-m are registered in the termination-processing point data D2.

When PCs are registered, all of the bits of M-S-U are usually not specified because if all of the bits are specified, the value registered in the termination-processing point data D2 needs to be updated whenever a certain signaling point in a remote zone is added or deleted. This would be very complicated. (In a word, if the registration is performed by specifying a range including U, the registered value of U needs to be updated for any addition or deletion of a signaling point.)

Hence, registration in the termination-processing point data D2 is performed on a remote zone by remote zone basis. In other words, registration is performed by specifying M (specifying only main zone numbers) or specifying M-S (specifying main and sub zone numbers). For example, in the case of FIG. 11, registration is performed by specifying M-S for an index of 000 or 001, and registration is performed by specifying M for an index of 002.

In addition, a related index associated with the index of the call-processing point data D1 is registered in the termination-processing point data D2. The related index describes indexes of the call-processing point data D1 which correspond to data records having PCs of the remote signaling points that are the same as the PCs of the remote signaling points described in the termination-processing point data D2.

Supposing that the signaling unit 11-1 has extracted, through code extraction processing, M=00101 and S=0011, the signaling unit 11-1 searches the termination-processing point data D2 for records in which M=00101 and S=0011 appear, and extracts indexes associated with the records.

A record in which M=00101 and S=0011 appear corresponds to the top record in the termination-processing point data D2 illustrated in FIG. 11, and the extracted related indexes are 000, 001, 002, 003, and 0095.

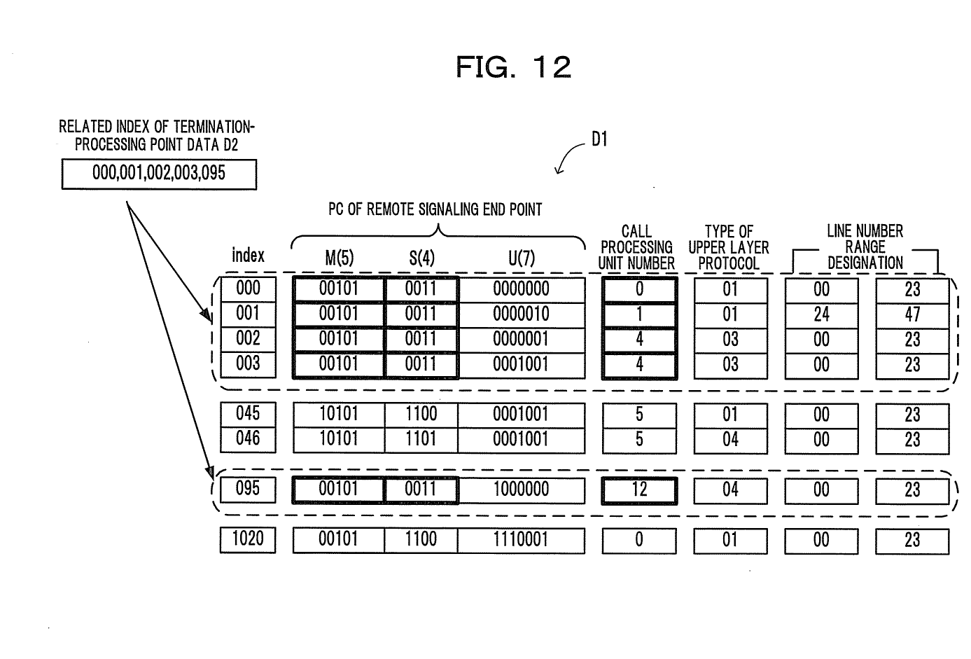

FIG. 12 is a diagram illustrating how the call-processing point data D1 is searched for corresponding PCs, using a related index. The signaling unit 11-1, after extracting related indexes from the termination-processing point data D2, searches the call-processing point data D1 for records corresponding to the related indexes. In this example, the records surrounded by dotted line frames in FIG. 12 are retrieved.

Then, the signaling unit 11-1 recognizes call processing unit numbers, and sends corresponding all-bit PCs each including the codes of the masked range and non-masked range to call processing units having the recognized call processing unit numbers. Since this is an operation similar to that in FIG. 9, the description thereof is omitted.

Thus, in the exemplary modification described above, a signaling end point, upon receipt of a network management signal, first determines whether or not the signal is acceptable to itself using the termination-processing point data D2, and then performs PC transfer control using the call-processing point data D1, and hence, reliability is increased.

According to the present invention, as described above, when a signaling unit notifies call processing units of a network management signal, signaling points to be processed are extracted on the basis of the network management signal including a wild card, by using the call-processing point data D1, and remote signaling points to be processed by the respective call processing units are extracted, whereby PCs of the remote signaling points which are to be served by respective call processing units are transferred.

This allows the processing load of the signaling units to be decreased, makes it so that filtering processing is not required at the call processing units, and allows the amount of communication data between the signaling units and the call processing units to be decreased. Hence, when a network management signal including a wild card is received, general load of reception processing can be decreased.

In addition, in a common channel signaling network, even when a serious failure occurs, signal communication information (information about the signal communication state between the signaling end point 10a and the remote signaling point group g1) can be promptly transmitted, thereby enhancing serviceability.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiments of the present invention have been described in detail, it should be understood that the various changes, substitutions, and alterations could be made hereto without departing from the spirit and scope of the invention.

What is claimed is:

1. A communication apparatus, comprising:
a signal termination unit that includes a point data management unit and performs reception processing by receiving a signal including an address code for identifying a plurality of remote signaling points; and
a plurality of call processing units that perform call processing for the plurality of the remote signaling points,
wherein, when a predetermined range of the address code is masked by a wild card and a signal is received that includes an address code constituted by a masked range and a non-masked range, the masked range being a masked portion of the address code and the non-masked range being a range of the address code not masked,
the point data management unit manages call-processing point data, which is a list showing which of the call processing units performs call processing for the remote signaling point specified by the given address code, by associating a call processing unit number for identifying the call processing unit with the address code describing all bits of a code set in the masked range and a code set in the non-masked range, and
wherein the signal termination unit, upon receipt of the signal, extracts a code of the non-masked range of the address code having a wild card, recognizes the call processing unit number corresponding to the extracted code of the non-masked range by referring to the call-processing point data, and transmits to the call processing unit having the recognized call processing unit number the corresponding address code describing all the bits of the code set in the masked range and the code set in the non-masked range.

2. The communication apparatus according to claim 1, wherein the signal termination unit, when a load of the call processing for the remote signaling point is higher than a predetermined load, creates the call-processing point data in such a manner as to associate a plurality of the call processing unit numbers with the address code describing all the bits of the code set in the masked range and the code set in the non-masked range, thereby causing the corresponding plurality of call processing units to perform load distributed processing.

3. A communication apparatus, comprising:
a signal termination unit that includes a point data management unit and performs reception processing by receiving a signal including an address code for identifying a plurality of remote signaling points; and
a plurality of call processing units that perform call processing for the plurality of the remote signaling points,
wherein, when a predetermined range of the address code is masked by a wild card and a signal is received which includes an address code constituted by a masked range and a non-masked range, the masked range being a masked portion of the address code and the non-masked range being a range of the address code not masked, the point data management unit manages termination-processing point data, which is a list of address codes acceptable thereto, the list describing a code of the non-masked range, and manages call-processing point data, which is a list showing which of the call processing units performs call processing for the remote signaling point specified by the given address code, by associating a call processing unit number for identifying the call processing unit with the address code describing all bits of a code set in the masked range and a code set in the non-masked range, and
wherein the signal termination unit, upon receipt of the signal, through searching for matching between the non-masked range of the address code having a wild card and the termination-processing point data, extracts the non-masked range that matches the termination-processing point data, recognizes the call processing unit number corresponding to the extracted code of the non-masked range by referring to the call-processing point data, and transmits to the call processing unit having the recognized call processing unit number the corresponding address code describing all the bits of the code set in the masked range and the code set in the non-masked range.

4. The communication apparatus according to claim 3, wherein the signal termination unit, when a load of the call processing for the remote signaling point is higher than a predetermined load, creates the call-processing point data in such a manner as to associate a plurality of the call processing unit numbers with the address code describing all the bits of the code set in the masked range and the code set in the non-masked range, thereby causing the corresponding plurality of call processing units to perform load distributed processing.
